(19) United States
(12) Patent Application Publication
(10) Pub. No.: US 2008/0054619 A1
(43) Pub. Date: Mar. 6, 2008

(54) BOOK JACKET WITH WINDOW

(76) Inventor: Kimberly A. Barth, Norristown, PA (US)

Correspondence Address: WILLIAM H. EILBERG, THREE BALA PLAZA, SUITE 501 WEST, BALA CYNWYD, PA, 19004, US

(21) Appl. No.: 11/845,926

(22) Filed: Aug. 28, 2007

Related U.S. Application Data
(60) Provisional application No. 60/823,835, filed on Aug. 29, 2006.

(51) Int. Cl. B42D 3/00; B23P 19/00

(52) U.S. Cl. 281/29; 29/700

(57) ABSTRACT

A book jacket includes a thin, foldable transparent or translucent material. The jacket includes a generally rectangular body which is free of adhesive, and a plurality of flaps, extending from the body, the flaps having adhesive material. The jacket is fitted around a book by laying the book against the body, and folding the flaps onto the interior surfaces of the book covers so as to engage such surfaces adhesively. Thus, the book jacket is permanently affixed, by adhesive, the affixation being accomplished only by the flaps, and only at the interior surfaces of the book covers.

### CROSS-REFERENCE TO PRIOR APPLICATION

Priority is claimed from U.S. provisional patent application Ser. No. 60/823,835, filed Aug. 29, 2006, the complete disclosure of which is incorporated by reference herein.

### FIELD OF THE INVENTION

The present invention generally relates to book jackets and dust covers that can be placed around books, and, more particularly, to book jackets and dust covers that can protect the cover of a book without obscuring the design or information contained on the outer surface of the cover.

### BACKGROUND OF THE INVENTION

Book jackets or dust covers of various types for the protection of books are well known in the art. The jackets can have a broad variety of shapes, e.g. a plain rectangular paper folded around the outer, front and back covers of the book to be protected and affixed with tape or the like. See, for example, U.S. Pat. No. 1,595,002 to Davis, U.S. Pat. No. 2,145,099 to Sharp, U.S. Pat. No. 4,209,187 to Forrest, and U.S. Pat. No. 4,341,401 to Arntzen. These exemplary book jackets are generally cumbersome to apply, particularly when the jacket has a decorative display that needs to overlay the outer front book cover, and thus requires careful alignment to obtain a proper fit.

Other book jackets and dust covers are known, such as in U.S. Pat. Nos. 713,176, 2,311,153, 4,259,799, 4,715,619, 4,856,656, 4,863,191, 5,013,068, 5,087,078, 5,092,630, 5,183,295, 5,429,238, 5,470,109, 5,472,237, 6,340,530, 6,435,559, and 6,666,641. All of the patents cited above are hereby incorporated herein by reference.

As a consequence, there has been a long-felt need for a book jacket that is easy to assemble to the outer cover of a book, that is substantially permanent, and that allows for viewing of the information or design located on the covered surface of the book.

### SUMMARY OF THE INVENTION

The present invention provides a permanent or semi-permanent protective book cover or jacket that is adhered to the covers of a book so that the information or design located on the covered surface of the book is visible.

The book jacket of the present invention includes a sheet of transparent or translucent foldable material. The sheet includes a generally rectangular body which is free of any adhesive, and a plurality of flaps extending from the body, the flaps containing an adhesive material. Thus, the flaps are the only portions of the book jacket which have adhesive. The flaps preferably have release strips which protect the adhesive until the jacket is to be applied to a book.

The flaps are intended to be folded over, such that they adhesively engage the interior surfaces of the covers of the book. Thus, when the jacket of the present invention is applied to a book, the engagement is solely by adhesion between the flaps and the interior surfaces of the covers, and the outer surfaces of the book covers are not adhered to the jacket. Moreover, the spine of the book is not adhered to the jacket by any adhesive material.

The invention also includes the combination of the book jacket and a book, with the jacket applied to the book as described above.

The invention also includes the method of attaching a book jacket to a book. The method includes placing the book over a sheet of material, the sheet including a rectangular body having no adhesive, and a plurality of flaps having adhesive. The flaps are then folded over and adhered to the interior surfaces of the covers of the book. Thus, the exterior surfaces of the covers of the book are not affixed to the jacket by any adhesive.

The invention therefore has the object of providing a protective cover or jacket for a book.

The invention has the further object of providing a protective cover which permits the viewing of indicia contained on the exterior surfaces of the covers of the book.

The invention has the further object of providing a protective cover or jacket for a book, wherein the jacket is not affixed by any adhesive to the exterior surfaces of the covers of the book, or to the spine of the book.

The invention has the further object of simplifying the process of affixing a protective jacket to a book.

The invention has the further object of making it unnecessary to squeeze out air pockets or bubbles from the region between a transparent or translucent book jacket and the underlying surface of the book.

The invention has the further object of providing a book cover or jacket which is permanently and adhesively fastened to a book.

The reader skilled in the art will recognize other objects and advantages of the present invention, from a reading of the following brief description of the drawings, the detailed description of the invention, and the appended claims.

### BRIEF DESCRIPTION OF THE DRAWINGS

FIG. 1 provides a perspective view of a book jacket formed in accordance with one embodiment of the invention.

FIG. 2 provides an elevational plan view of the book jacket shown in FIG. 1, with paper strips covering the adhesive surfaces of the flaps.

FIG. 3 provides a perspective view of the book jacket shown in FIGS. 1 and 2, with a book located on the jacket's inner surface ready for covering.

FIGS. 4-7 provide perspective views, in series, of the book jacket shown in FIGS. 1-3 being applied to a book located on its inner surface.

FIG. 8 provides a perspective view of a book covered by the book jacket of the present invention.

### DETAILED DESCRIPTION OF THE PREFERRED EMBODIMENT

This description of the preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “upwardly”, “top”, and “bottom”, as well as derivatives thereof, should be construed to refer to the orientation as then described or as shown in the drawing figure under discussion. These relative terms are for convenience of description and normally are not intended to require a particular orientation. Terms including “inwardly” versus “outwardly”, “longitudinal” versus “lateral” and the like are to be interpreted relative to one another or relative to an axis of elongation, or an axis or center of rotation, as appropriate.

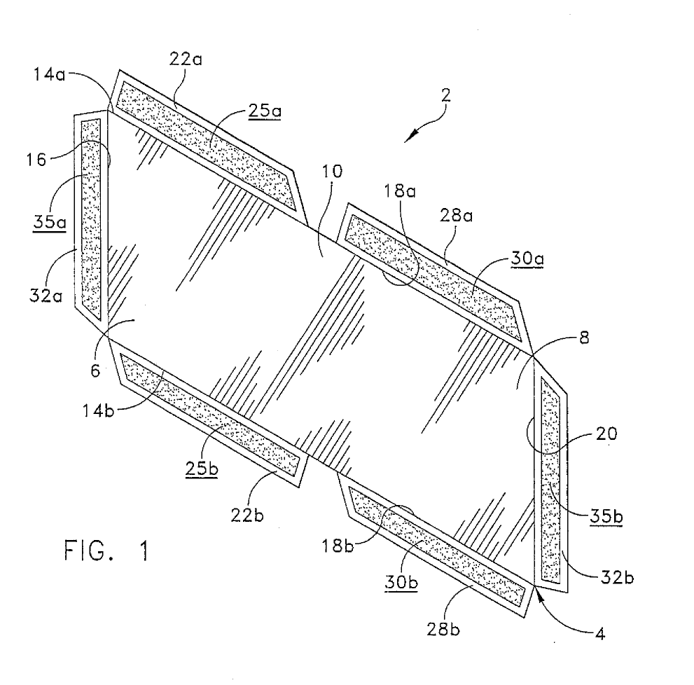

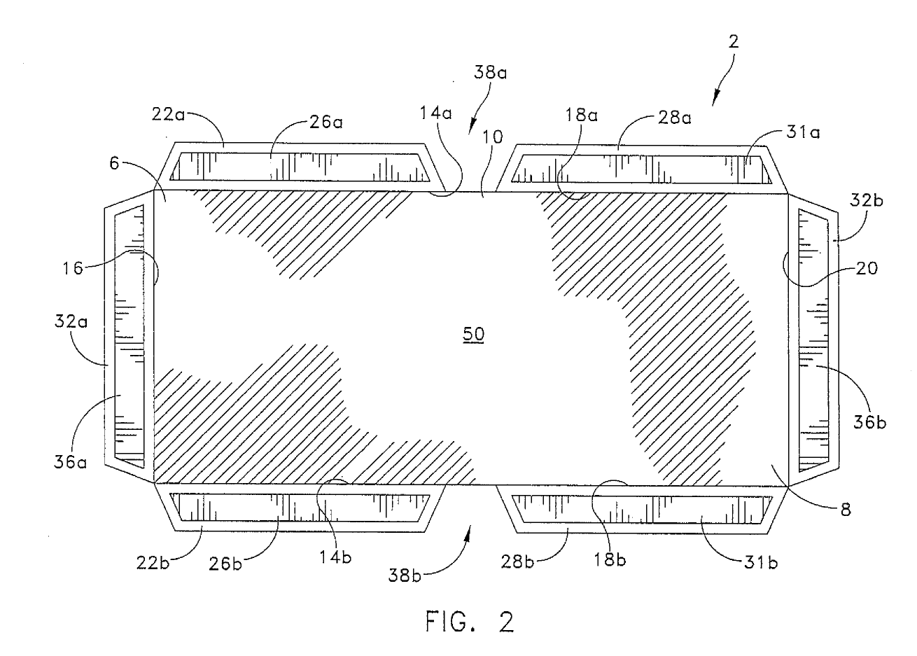

As shown in FIGS. 1 and 2, a book jacket 2 may be formed in accordance with one embodiment of the present invention that comprises a thin, foldable and flexible sheet 4, that is often rectangular in peripheral shape. Sheet 4 includes a front-covering segment 6 and a rear-covering segment 8 that are separated by a centrally disposed spine-covering segment 10. Sheet 4 is often formed from a transparent polymer, e.g. any of the sheet polyesters or sheet polypropylenes, sheet vinyls, or other flexible and transparent or translucent polymers known in the art.

Front-covering segment 6 includes a top-edge 14a and a bottom-edge 14b that are often substantially parallel to one another. An end-edge 16 extends from top-edge 14a to bottom edge 14b in spaced relation to centrally disposed spine-covering segment 10. Rear covering segment 8 includes a top-edge 18a and a bottom-edge 18b that are also often substantially parallel to one another. An end-edge 20 extends from top-edge 18a to bottom-edge 18b in spaced relation to centrally disposed spine-covering segment 10 and end-edge 16 of front-covering segment 6.

A top flap 22a projects outwardly from top-edge 14a and a bottom-flap 22b projects outwardly from bottom-edge 14b. Each of top flap 22a and bottom-flap 22b extend from centrally disposed spine-covering segment 10 to end edge 16, and are foldable about the lines that are defined by top-edge 14a and bottom-edge 14b, respectively. Top flap 22a includes an adhesive covered interior surface 25a and bottom flap 22b includes an adhesive covered interior surface 25b. A strip 26a of release paper or the like is removably disposed over the top of adhesive covered interior surface 25a, and a strip 26b of release paper or the like is removably disposed over the top of adhesive covered interior surface 25b (FIG. 2).

Similarly, a top flap 28a projects outwardly from top-edge 18a and a bottom-flap 28b projects outwardly from bottom-edge 18b. Each of top flap 28a and bottom-flap 28b extend from centrally disposed spine-covering segment 10 to end edge 20, and are foldable about the lines that are defined by top-edge 18a and bottom-edge 18b, respectively. Top-flap 28a includes an adhesive covered interior surface 30a and bottom-flap 28b includes an adhesive covered interior surface 30b. A strip 31a of release paper or the like is removably disposed over the top of adhesive covered interior surface 28a, and a strip 31b of release paper or the like is removably disposed over the top of adhesive covered interior surface 28b (FIG. 2).

An end-flap 32a projects outwardly from end edge 16 of front-covering segment 6 and a second end-flap 32b projects outwardly from end edge 20 of rear-covering segment 8. End-flap 32a extends from top-edge 14a to bottom-edge 14b, and is foldable about the line defined by end-edge 16. Likewise, second end-flap 32b extends from top-edge 18a to bottom-edge 18b, and is foldable about the line defined by end-edge 20. End-flap 32a includes an adhesive covered interior surface 35a and second end-flap 32b includes an adhesive covered interior surface 35b. A strip 36a of release paper or the like is removably disposed over the top of adhesive covered interior surface 35a, and a strip 36b of release paper or the like is removably disposed over the top of adhesive covered interior surface 35b. As a result of this construction, centrally disposed spine-covering segment 10 extends from top-edge 14a to bottom-edge 14b, and from top-edge 18a to bottom-edge 18b so that a gap 38a is defined between the inner edges of top-flap 22a and top-flap 28a. Also, a gap 38b is defined by the inner edges of bottom-flap 22b and bottom-flap 28b. Additionally, the portions of sheet 4 that extend between top-edge 14a, bottom-edge 14b, top-edge 18a, bottom-edge 18b, and end-edge 16, end-edge 20 define an interior surface 50 that is transparent or at least translucent.

As used in this specification, the term “body” refers to the portion of the sheet 4 which does not include the flaps. More specifically, the body of the sheet includes the generally rectangular portion which does not include the top and bottom flaps or the end flaps. Thus, the body plus the flaps together comprise the sheet 4.

The body is therefore the portion of the book jacket which is intended to abut the exterior front and back covers of the book, as well as the spine of the book.

It is a feature of the present invention that the body of the sheet has no adhesive. The only adhesive in the book jacket of the present invention is the adhesive provided on the top and bottom and end flaps, as described above. Thus, when a book is laid over a portion of the body, the book is not adhesively affixed to the body. Instead, the sheet is affixed to the book by the adhesive provided on the flaps. The body is free of adhesive material.

In the preferred embodiment shown in the drawings, the flaps are generally trapezoidal in configuration. This shape facilitates manipulation of the flaps during application of the jacket to a book. Other shapes could be used, within the scope of the invention.

Sheet 4, before it is used, is a generally planar structure. Thus, the sheet (or a stack of such sheets) can be stored easily by stacking them. The figures, such as FIG. 2, for example, show that before the sheet has been used, the body and the flaps lie in substantially the same plane.

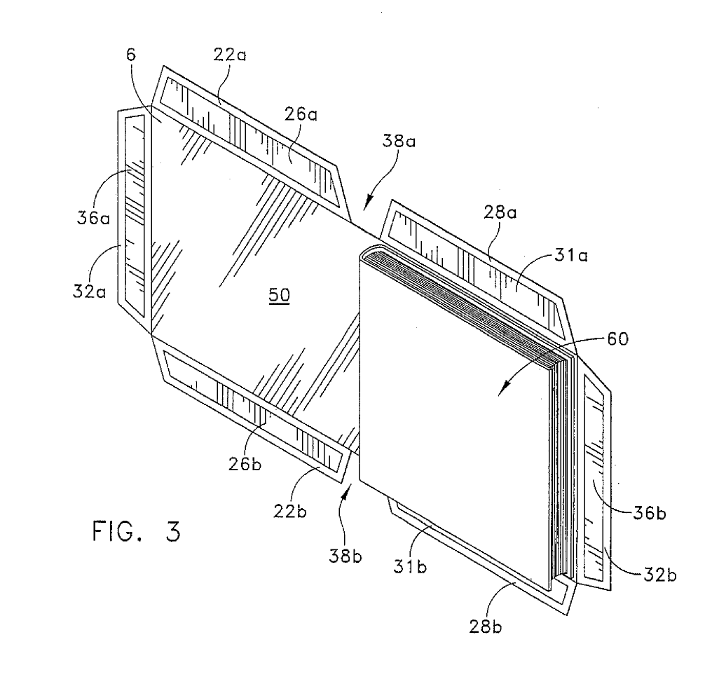

As shown in FIGS. 3-8, book jacket 2 is assembled to a book 60 in the following manner. Book jacket 2 is laid upon a flat surface so that interior surface 50 is facing upwardly. Once in this position, book 60 is placed onto interior surface 50 of book jacket 2 so that the book's spine is disposed in parallel contacting relation to spine-covering segment 10. When book 60 is properly arranged on interior surface 50 of book jacket 2, the edges of the book's front cover 65 or back cover 68 abut to top-edge 14a, bottom-edge 14b, top-edge 18a, bottom-edge 18b and either end-edge 16 or end-edge 20. As a result, top flap 22a and top flap 28a project outwardly away from the corresponding top edges of book 60, while bottom-flap 22b and bottom-flap 28b project outwardly away from the corresponding bottom edges of book 60. Additionally, either end-flap 32a or second end-flap 32b projects outwardly away from the corresponding end edge of book 60 (FIG. 3).

Since the book, as shown in FIG. 3, overlies a portion of the body of sheet 4, and not any of the flaps, the book is, so far, not adhered to the sheet. That is, there is, so far, no adhesion between the interior surface 50 and the book jacket.

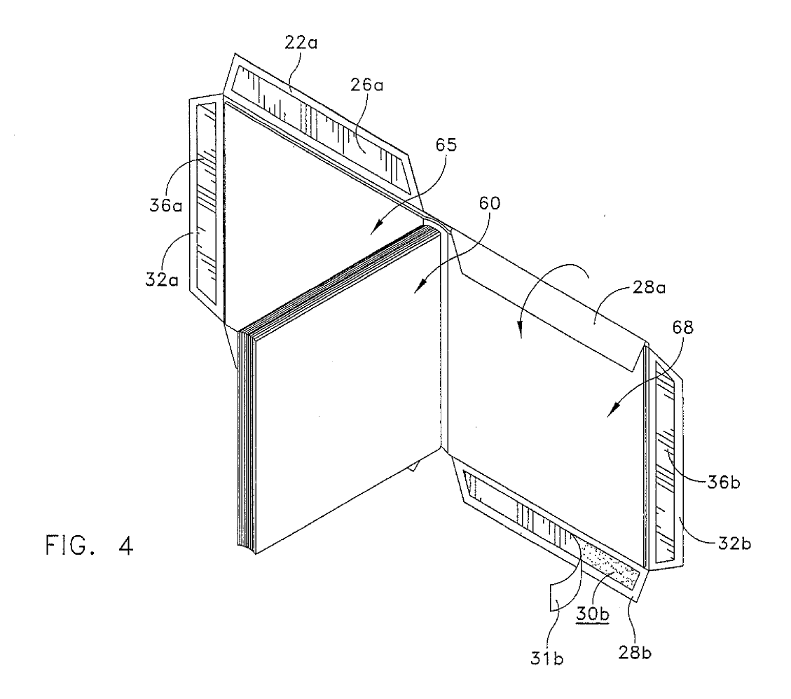

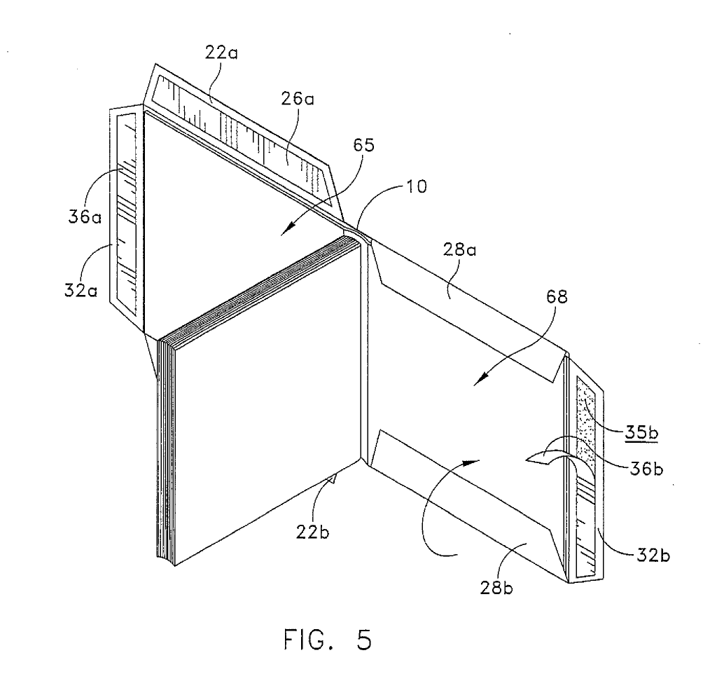

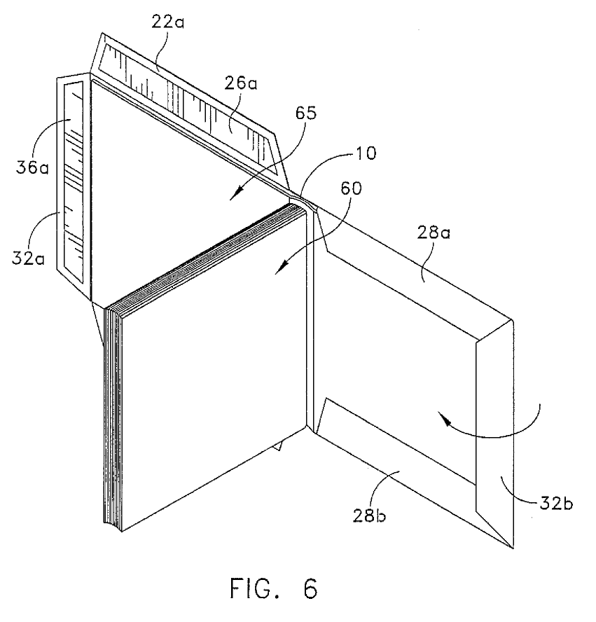

With book 60 in position on interior surface 50 of book jacket 2, the strips 31a, 31b may be removed from top-flap 28a and bottom-flap 28b, respectively (FIGS. 4-7). Once in the arrangement, top-flap 28a and bottom-flap 28b may be folded over onto the inner surface of book cover 68 along top-edge 18a and bottom-edge 18b so that adhesive surfaces 30a and 30b engage and adhere to the inner surface of book cover 68. Similarly, top-flap 22a and bottom-flap 22b may be folded over onto the inner surface of book cover 65 along top-edge 14a and bottom-edge 14b so that adhesive surfaces 25a and 25b engage and adhere to the inner surface of book cover 65 (FIGS. 5-6).

Once top-flaps 22a, 28a and bottom-flaps 22b, 28b are adhered to the inner surfaces of their respective book covers 65, 68, end-flap 32a and second end-flap 32b may be engaged. More particularly, strip 36b is first removed from interior surface 35b so as to expose the underlying adhesive. End-flap 32a is then folded over onto the inner surface of book cover 68 that extends parallel to end-edge 20 of sheet 4 so that adhesive surface 35b engages and adheres to the inner surface of book cover 68.

At this point, the book is adhered to the sheet, but only through the adhesive provided on the flaps which have been folded over.

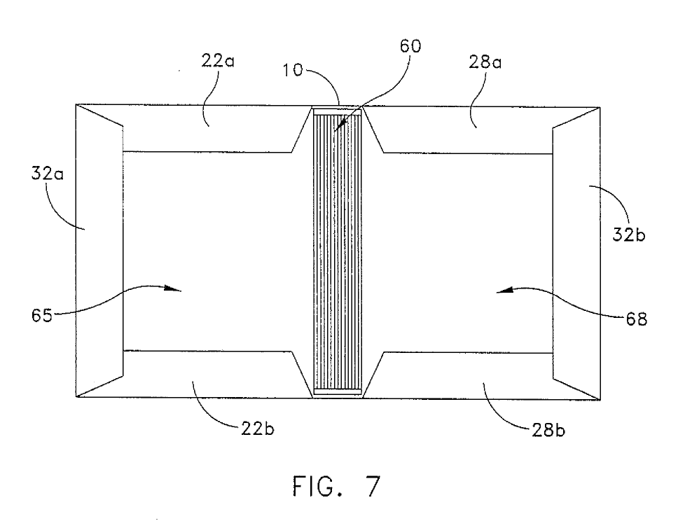

Likewise, strip 36a is first removed from interior surface 35a so as to expose the underlying adhesive. End-flap 32a is then folded over onto the inner surface of book cover 65 that extends parallel to end-edge 16 of sheet 4 so that adhesive surface 35a engages and adheres to the inner surface of book cover 65 (FIG. 7).

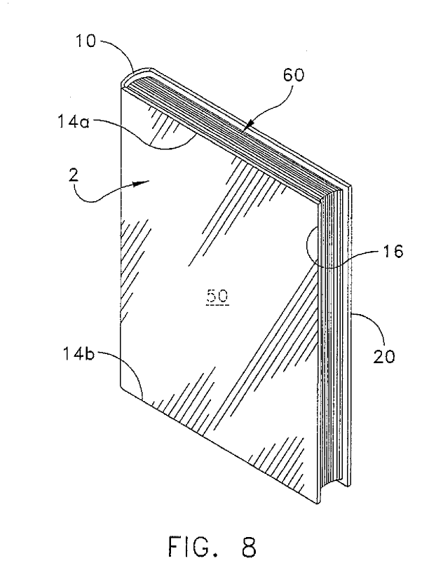

As a result of this construction, book 60 comprises a permanent jacket that is transparent or at least translucent so that the outer surfaces of the underlying book are visible (FIG. 8).

Because the book jacket is adhered to the book, through the adhesive provided on the flaps, the book jacket is not re-usable. The book jacket of the present invention is intended to be permanently affixed to the book.

By providing adhesive only on the flaps, one avoids the inconvenience of having to remove air pockets from the spaces between the book jacket and a surface of the book. There is no adhesion between the body of the sheet forming the jacket, and the outer surfaces of the book. Indeed, the only adhesion occurs at the inner surfaces of the book covers, because those are the only locations where the adhesive flaps can be affixed.

The book jacket of the present invention can be made to fit books of various thicknesses. The jacket is preferably pre-cut to fit a book having the thickness of a thick magazine, whose spine is, say, 0.25 inches thick. If the user wants to apply the same book jacket to cover a much thicker book, say, a book having a two-inch spine, the user would simply trim the top and bottom flaps, in the locations immediately adjacent to the spine, so as to accommodate the book having the thicker spine. Thus, the book jacket of the present invention can be used to cover relatively thin magazines, as well as very thick books.

In summary, the present invention provides a book jacket which is permanently affixed to a book by an adhesive, but in which neither the spine nor the front cover nor the back cover is adhered to the jacket. The book jacket contains adhesive only on its flaps and not on its body. The book jacket is transparent or translucent, allowing the user to view the indicia contained on the front and back covers of the book.

The book jacket of the present invention is very simple to install. Once the sheet 4 has been formed, no cutting is required of the user (except when the user wants to adapt the jacket to a much thicker book). Only simple folding operations (plus removal of the protective strips from the adhesive) are required. Because it is not necessary to use adhesive on the front and back covers, there is no need to squeeze out air bubbles or pockets.

The book jacket of the present invention also does not include any pockets or envelopes into which the covers of the book are inserted. Unlike prior art book jackets in which the jacket is held onto the book because of the insertion of a book cover into a pocket, the book jacket of the present invention is permanently affixed by adhesion of the flaps to the interior surfaces of the book covers.

The sheet 4 forming the book jacket of the present invention may be a unitary piece of material. That is, the flaps can be integral with the sheet. The latter is the preferred embodiment. But the sheet could also be constructed by forming the body and the flaps separately, and by joining the flaps to the body.

It is to be understood that the present invention is by no means limited only to the particular constructions herein disclosed and shown in the drawings, but also comprises any modifications or equivalents within the scope of the claims.

What is claimed is:

1. A book jacket comprising:
a) a sheet of transparent or translucent foldable material,
b) the sheet including a body which is generally rectangular, the body being free of any adhesive material,
c) the sheet also including a plurality of flaps extending from the body, at least some of the flaps including an adhesive material,
d) wherein at least some of the flaps have a release strip for removably covering the adhesive material on the flap.

2. The book jacket of claim 1, wherein at least some of the flaps have a trapezoidal shape.

3. The book jacket of claim 1, wherein all of the flaps have adhesive material.

4. The book jacket of claim 1, wherein the body includes a top edge, a bottom edge, and end edges, and wherein there are two flaps extending from the top edge, two flaps extending from the bottom edge, and at least one flap extending from each end edge.

5. The book jacket of claim 1, wherein the body and the flaps lie in substantially a same plane.

6. In combination, a book and a book jacket, the book jacket comprising:
a) a sheet of transparent or translucent foldable material,
b) the sheet including a body which is generally rectangular, the body being free of any adhesive material,
c) the sheet also including a plurality of flaps extending from the body, at least some of the flaps including an adhesive material,
d) the book having a front cover, a back cover, and a spine, the front cover and back cover each having interior and exterior surfaces, the sheet being arranged around the book such that the exterior surfaces of the front cover and the back cover, and the spine of the book, are in abutment only with the body and not with the flaps,
wherein at least some of the flaps are folded over to adhere to some of the interior surfaces of the front and back covers.

7. The combination of claim 6, wherein at least some of the flaps have a trapezoidal shape.

8. The combination of claim 6, wherein all of the flaps have adhesive material.

9. The combination of claim 6, wherein the body includes a top edge, a bottom edge, and end edges, and wherein there are two flaps extending from the top edge, two flaps extending from the bottom edge, and at least one flap extending from each end edge.

10. A method of affixing a book jacket to a book, the book jacket including a sheet of transparent or translucent foldable material, the sheet including a body which is generally rectangular, the body being free of any adhesive material, the sheet also including a plurality of flaps extending from the body, at least some of the flaps including an adhesive material, the book having a front cover, a back cover, and a spine, the front cover and back cover each having interior and exterior surfaces, wherein the method comprises:
a) placing the book such that at least one of said exterior surfaces of one of said covers is in abutment with said body,
b) folding at least some of the flaps so as to engage adhesively the interior surface of at least one of said covers,
wherein step (a) is performed without applying any adhesive to the book, and wherein step (b) comprises the sole application of adhesive to the book, wherein the jacket is affixed to the book by adhesive only on an interior surface of said at least one of said covers.

11. The method of claim 10, wherein the flaps include release strips which protect the adhesive material, and wherein step (b) is preceded by removing said release strips from the flaps.

12. The method of claim 10, wherein the body includes a top edge, a bottom edge, and end edges, and wherein there are two flaps extending from the top edge, two flaps extending from the bottom edge, and at least one flap extending from each end edge, and wherein step (b) comprises folding all of said flaps such that the flaps adhesively engage interior surfaces of the front and back covers.

13. The method of claim 12, wherein step (b) comprises folding one of the flaps extending from the top edge onto the interior surface of the front cover of the book, and folding another of the flaps extending from the top edge onto the interior surface of the back cover of the book.

14. The method of claim 13, wherein step (b) further comprises folding one of the flaps extending from the bottom edge onto the interior surface of the front cover of the book, and folding another of the flaps extending from the bottom edge onto the interior surface of the back cover of the book.

15. The method of claim 10, wherein at least some of the flaps have portions which are adjacent to the spine, and wherein step (a) is preceded by the step of trimming said at least some of the flaps so as to accommodate a book having a thicker spine.
